(19) United States
(12) Patent Application Publication
(10) Pub. No.: US 2025/0382745 A1
(43) Pub. Date: Dec. 18, 2025

(54) REFINING DEVICE

(71) Applicant: SEIKO EPSON CORPORATION, Tokyo (JP)

(72) Inventor: Yuta INAGAKI, Matsumoto (JP)

(21) Appl. No.: 19/234,323

(22) Filed: Jun. 11, 2025

(30) Foreign Application Priority Data
Jun. 13, 2024 (JP) 2024-095836

(51) Int. Cl. D21B 1/10; D21F 9/00

(52) U.S. Cl. CPC D21B 1/10; D21F 9/00

(57) ABSTRACT

There is provided a refining device including: a casing that has a supply port to which a raw material containing a fiber is supplied and a discharge port for discharging a refined product obtained by refining the raw material; a rotor that is rotatably installed in the casing and has a plurality of blades disposed radially from a rotation axis; a filter member that is installed in the casing to cover an outer periphery of the rotor and is composed at least partially of a mesh; and a flow rectifying member that is positioned in an annular space between the filter member and an inner peripheral surface of the casing and protrudes toward the discharge port.

The present application is based on, and claims priority from JP Application Serial Number 2024-095836, filed Jun. 13, 2024, the disclosure of which is hereby incorporated by reference herein in its entirety.

### BACKGROUND

### 1. Technical Field

The present disclosure relates to a refining device.

### 2. Related Art

A sheet manufacturing apparatus including a crushing section that crushes a waste paper sheet, a defibration section that defibrates small fragment-like crushed pieces obtained by the crushing section, an accumulation section for accumulating defibrated products obtained by the defibration section on a flat surface, a heating/pressurization section that heats and pressurizes accumulated web, a cutting section that cuts a sheet obtained by the heating/pressurization section into a predetermined shape, and a sheet collection section that collects the obtained sheet is known.

As the defibration section in the sheet manufacturing apparatus, for example, a refining device as described in JP-A-2023-18828 can be used. The refining device described in JP-A-2023-18828 includes a casing having a supply port and a discharge port, a rotating section having a defibrated blade and rotating in the casing, and a mesh disposed on an outer peripheral portion of the rotating section. The material supplied from the supply port is defibrated by the defibrating blade, and a defibrated product, that is, a refined product is generated.

However, in the refining device described in JP-A-2023-18828, depending on the conditions such as the degree of refining of the refined product, the amount of the refined product, and the flow rate of the gas in the casing, the refined product may stay at various locations in the casing, particularly in the vicinity of the discharge port. When the refined product stays in the vicinity of the discharge port in the casing, it becomes difficult to smoothly discharge the refined product from the defibration section. As a result, there is a concern that the apparatus is frequently stopped and the production efficiency is lowered, or the sheet quality is adversely affected.

### SUMMARY

According to an aspect of the present disclosure, there is provided a refining device including a casing that has a supply port to which a raw material containing a fiber is supplied and a discharge port for discharging a refined product obtained by refining the raw material, a rotor that is rotatably installed in the casing and has a plurality of blades disposed radially from a rotation axis, a filter member that is installed in the casing to cover an outer periphery of the rotor and is at least partially made of a mesh, and a flow rectifying member that is positioned in an annular space between the filter member and an inner peripheral surface of the casing and protrudes toward the discharge port.

### BRIEF DESCRIPTION OF THE DRAWINGS

FIG. 1 is a configuration diagram illustrating an outline of a sheet manufacturing apparatus including a refining device according to a first embodiment of the present disclosure.

FIG. 2 is a perspective view of the refining device illustrated in FIG. 1.

FIG. 3 is a perspective view of a rotor included in the refining device illustrated in FIG. 2.

FIG. 4 is a cross-sectional view taken along the line IV-IV in FIG. 2.

FIG. 5 is a cross-sectional view taken along the line V-V in FIG. 2.

FIG. 6 is an enlarged cross-sectional view of the vicinity of a discharge port in FIG. 5.

FIG. 7 is an enlarged cross-sectional view in the vicinity of a discharge port provided in the refining device according to a second embodiment of the present disclosure.

FIG. 8 is a lateral cross-sectional view of a refining device according to a third embodiment of the present disclosure.

### DESCRIPTION OF EMBODIMENTS

Hereinafter, a refining device of the present disclosure will be described in detail based on a preferred embodiment illustrated in the accompanying drawings.

### First Embodiment

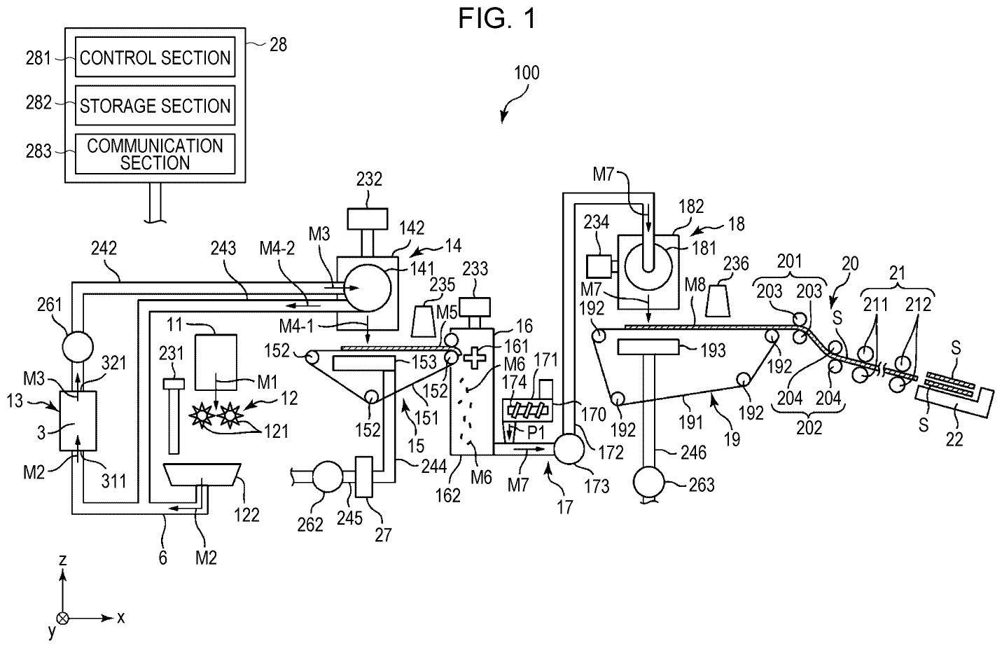

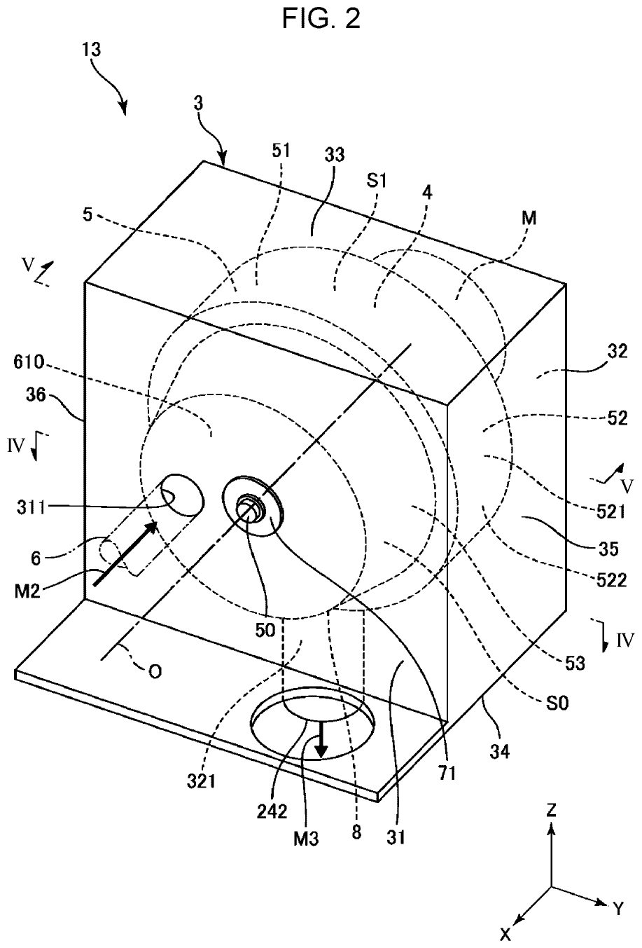

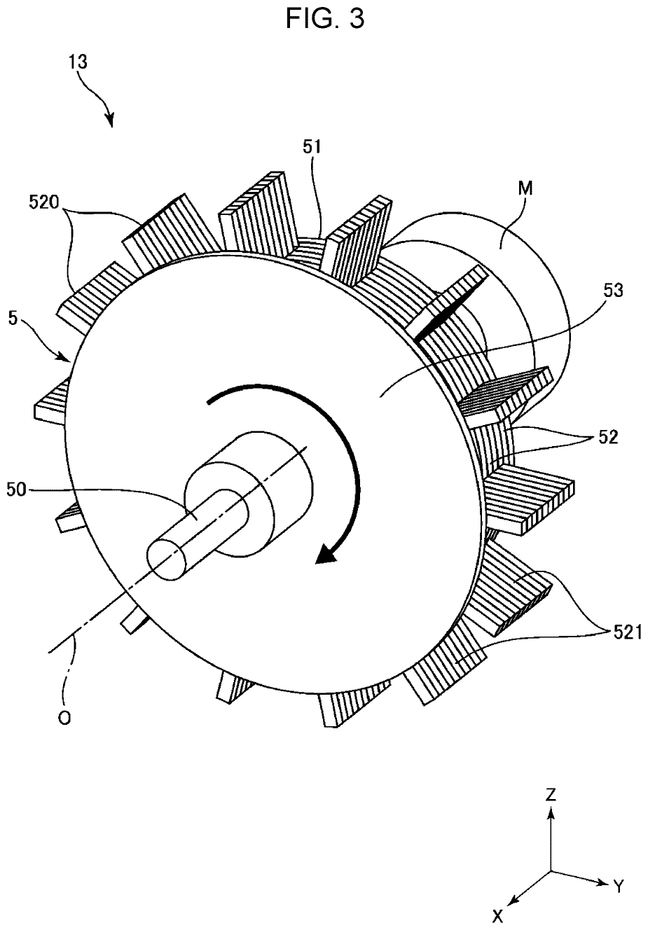

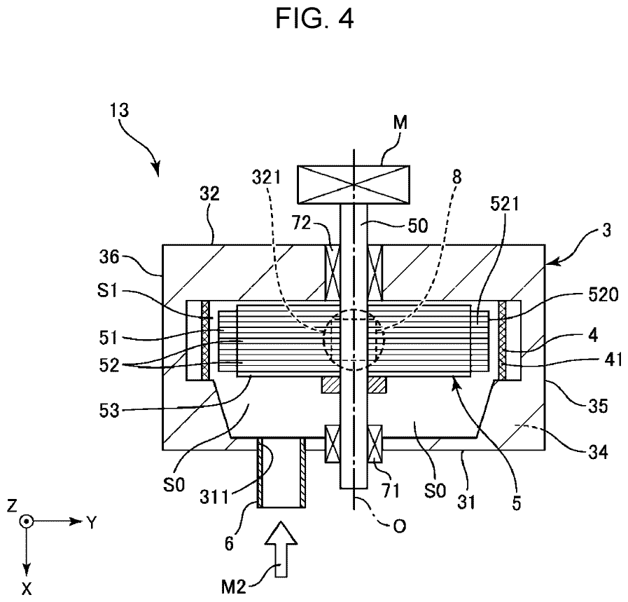

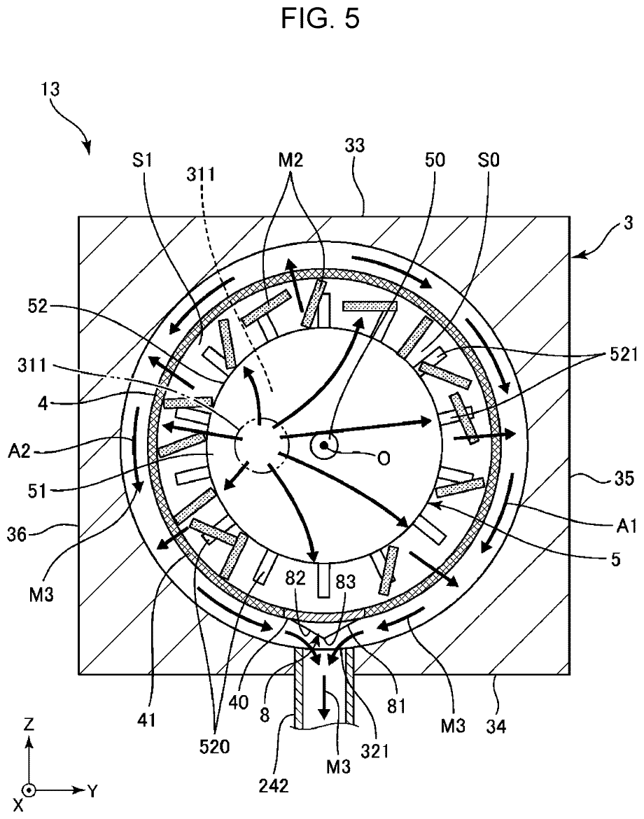

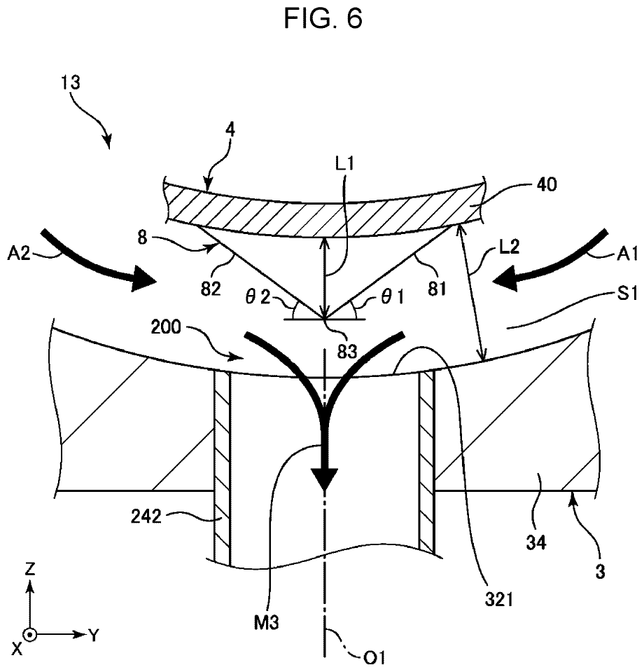

FIG. 1 is a configuration diagram illustrating an outline of a sheet manufacturing apparatus including a refining device according to a first embodiment of the present disclosure. FIG. 2 is a perspective view of the refining device illustrated in FIG. 1. FIG. 3 is a perspective view of a rotor included in the refining device illustrated in FIG. 2. FIG. 4 is a cross-sectional view taken along the line IV-IV in FIG. 2. FIG. 5 is a cross-sectional view taken along the line V-V in FIG. 2. FIG. 6 is an enlarged cross-sectional view of the vicinity of a discharge port in FIG. 5.

In the following description, the upper side of FIGS. 1, 2, 3, 5, and 6 may be referred to as “upper”, “upper side”, or “above”, and the lower side may be referred to as “lower”, “lower side”, or “below”. In addition, FIG. 1 is a schematic configuration diagram, and the positional relationship, orientation, size, and the like of each section of a sheet manufacturing apparatus 100 are not limited to those illustrated. In addition, in FIG. 1, a direction in which a crushed piece M2, a defibrated product M3, a first sorted product M4-1, a second sorted product M4-2, a first web M5, a subdivided body M6, a mixture M7, a second web M8, and a sheet S are transported, that is, a direction indicated by an arrow is also referred to as a transport direction. Further, the tip end side of the arrow in FIG. 1 is also referred to as “downstream” in the transport direction, and the base end side of the arrow in

FIG. 1 is also referred to as “upstream” in the transport direction. In addition, in each drawing, an X axis, a Y axis, and a Z axis that are orthogonal to each other are set, and a direction indicated by an arrow is referred to as a + side, and the opposite side is referred to as a − side in each axis.

The sheet manufacturing apparatus 100 illustrated in FIG. 1 is a sheet manufacturing apparatus 100 that generates the sheet S from a raw material M1 which is a waste paper sheet such as used copy paper.

As illustrated in FIG. 1, the sheet manufacturing apparatus 100 includes a raw material supply section 11, a crushing section 12, a refining device 13 which is an example of the refining device of the present disclosure, a sorting section 14, a first web forming section 15, a subdivision section 16, a mixing section 17, a dispersion section 18, a second web forming section 19, a molding section 20, a cutting section 21, a stock section 22, and a collection section 27.

In addition, the sheet manufacturing apparatus 100 includes a humidification section 231, a humidification section 232, a humidification section 233, a humidification section 234, a humidification section 235, and a humidification section 236. In addition, the sheet manufacturing apparatus 100 includes a blower 173, a blower 261, a blower 262, and a blower 263.

Further, in the sheet manufacturing apparatus 100, a raw material supply step, a crushing step, a refining step, a sorting step, a first web forming step, a division step, a mixing step, a loosening step, a second web forming step, a sheet forming step, and a cutting step are executed in this order.

Hereinafter, the configurations of each section will be described.

The raw material supply section 11 is a part that performs the raw material supply step of supplying the raw material M1 to the crushing section 12. The raw material M1 is a sheet-like material made of a fiber-containing material containing cellulose fibers. The cellulose fiber may be a fibrous material containing cellulose, which is a compound, as a main component, and may contain hemicellulose and lignin in addition to the cellulose. In addition, the raw material M1 may have any form such as a woven fabric or a non-woven fabric. Further, the raw material M1 may be, for example, recycled paper recycled and manufactured by defibrating a waste paper sheet, or Yupo Synthetic Paper (registered trademark), or may not be recycled paper.

The crushing section 12 is a part that performs the crushing step of crushing, in the air such as in the atmosphere, the raw material M1 supplied from the raw material supply section 11. The crushing section 12 has a pair of crushing blades 121 and a chute 122.

By rotating the pair of crushing blades 121 in opposite directions, the raw material M1 can be crushed therebetween, that is, cut into the crushed pieces M2. The shape and size of the crushed pieces M2 are preferably suitable for the refinement treatment in the refining device 13. Examples of the shape of the crushed piece M2 include a small piece having a square planar shape and a rectangular shape, particularly a strip-shaped small piece. In the following description, the crushed pieces M2 are also referred to as small pieces.

Further, the size of the crushed piece M2 is preferably, for example, a small piece having an average length of one side of 100 mm or less, and more preferably 3 mm or more and 70 mm or less. The shape of the small piece may be other than a square shape or a rectangular shape. In addition, it is preferable that the thickness be 0.07 mm or more and 0.10 mm or less.

The chute 122 is disposed below the pair of crushing blades 121 and has a funnel shape, for example. As a result, the chute 122 can receive the crushed piece M2 that was crushed by the crushing blade 121 and fell.

Further, above the chute 122, a humidification section 231 is disposed adjacent to the pair of crushing blades 121. The humidification section 231 humidifies the crushed piece M2 in the chute 122. The humidification section 231 has a filter containing moisture, and includes a vaporization type or hot air vaporization type humidifier that supplies humidified air with increased humidity to the crushed piece M2 by passing air through the filter. By supplying the humidified air to the crushed piece M2, adhesion of the crushed piece M2 to the chute 122 or the like due to static electricity can be suppressed.

The chute 122 is coupled to the upstream of the refining device 13 through a pipe body 6. That is, the downstream end portion of the pipe body 6 is coupled to a supply port 311 of the refining device 13 illustrated in FIG. 2. The crushed pieces M2 collected on the chute 122 pass through the pipe body 6 and are transported to the refining device 13.

As illustrated in FIG. 1, the refining device 13 is a part that performs a refining step of refining the crushed piece M2 in the air, that is, by a dry method. By the refinement treatment in the refining device 13, the refined product can be generated from the crushed pieces M2. The refining is a process of finely cutting and subdividing the raw material such as defibrating and crushing, and is described as defibrating in the present embodiment. That is, the refining device 13 performs defibration treatment on the crushed piece M2 as a raw material to generate the defibrated product M3 as a refined product.

Here, “defibrating” refers to disentangling the crushed piece M2 formed by binding a plurality of fibers into each fiber. Then, the disentangled material becomes the defibrated product M3. The shape of the defibrated product M3 is a linear shape or a band shape. In addition, the defibrated products M3 may exist in a state of being intertwined and agglomerated, that is, in a state of forming a so-called “lump”.

In addition, the refining device 13 can generate a flow of air from the crushing section 12 toward the sorting section 14, that is, an airflow, by the operation of the blower 261 described later and the rotation of the rotor 5. As a result, the crushed piece M2 can be introduced from the pipe body 6 to the upstream of the refining device 13, and after the refinement treatment, the defibrated product M3 can be delivered to the sorting section 14 through a pipe 242.

The pipe 242 is coupled to a discharge port 321, which is the downstream of the refining device 13. The blower 261 configured as, for example, a turbo type fan is installed in the middle of the pipe 242. The blower 261 is an airflow generation device that generates an airflow toward the sorting section 14. As a result, the introduction of the crushed piece M2 into the refining device 13 and the delivery of the defibrated product M3 to the sorting section 14 can be smoothly performed. As will be described later, due to the structure of the refining device 13, the passage and refinement treatment of the crushed piece M2, which is a raw material, are smoothly performed. However, the operation of the blower 261 installed on the downstream of the refining device 13 promotes the passage of the crushed pieces M2 through the refining device 13 and refinement treatment. Further, the blower 261 may be installed on the upstream of the refining device 13.

The sorting section 14 is a part that performs the sorting step of sorting the defibrated product M3 according to the size of a fiber length. In the sorting section 14, the defibrated product M3 is sorted into a first sorted product M4-1 and a second sorted product M4-2 having a fiber length larger than that of the first sorted product M4-1. The first sorted product M4-1 has a size suitable for the subsequent manufacturing of the sheet S. On the other hand, the second sorted product M4-2 includes, for example, those with insufficient defibration, those in which the defibrated fibers are excessively aggregated, and the like.

The sorting section 14 has a drum section 141 and a housing section 142 that stores the drum section 141.

The drum section 141 is formed of a cylindrical net body, and is a sieve that rotates around a central axis thereof. The defibrated product M3 flows into the drum section 141. Then, as the drum section 141 rotates, the defibrated product M3 smaller than the mesh opening of the net is sorted as the first sorted product M4-1, and the defibrated product M3 having a size equal to or larger than the mesh opening of the net is sorted as the second sorted product M4-2. The first sorted product M4-1 falls from the drum section 141.

On the other hand, the second sorted product M4-2 is delivered to a pipe 243 coupled to the drum section 141. The end portion of the pipe 243 on the side opposite to the drum section 141, that is, on the downstream is coupled to the middle of the pipe body 6. The second sorted product M4-2 that passed through the pipe 243 joins the crushed piece M2 in the pipe body 6 and flows into the refining device 13 together with the crushed piece M2. As a result, the second sorted product M4-2 is returned to the refining device 13 and is subjected to refinement treatment together with the crushed pieces M2.

In addition, the first sorted product M4-1 that fell from the drum section 141 falls when being dispersed in the air, and is oriented toward the first web forming section 15 positioned below the drum section 141. The first web forming section 15 is a part that performs the first web forming step of forming the first web M5 with the first sorted product M4-1. The first web forming section 15 includes a mesh belt 151, three tension rollers 152, and a suction section 153.

The mesh belt 151 is an endless belt on which the first sorted product M4-1 is accumulated. The mesh belt 151 is hung around three tension rollers 152. Then, the first sorted product M4-1 on the mesh belt 151 is transported to the downstream by the rotational drive of the tension roller 152.

The first sorted product M4-1 has a size equal to or larger than the mesh opening of the mesh belt 151. As a result, the passage of the first sorted product M4-1 through the mesh belt 151 is restricted, and accordingly, the first sorted product M4-1 can be accumulated on the mesh belt 151. In addition, since the first sorted product M4-1 is transported to the downstream together with the mesh belt 151 when being accumulated on the mesh belt 151, the first sorted product M4-1 is formed as the layered first web M5.

In addition, for example, there is a concern that dust, dirt, or the like will be mixed into the first sorted product M4-1. Dust or dirt may be generated by, for example, crushing or defibrating. Then, such dust or dirt will be collected by the collection section 27 which will be described later.

The suction section 153 is a suction mechanism that suctions air from below the mesh belt 151. As a result, dust or dirt that passed through the mesh belt 151 can be suctioned together with the air.

Further, the suction section 153 is coupled to the collection section 27 via a pipe 244. The dust or dirt suctioned by the suction section 153 is collected by the collection section 27.

A pipe 245 is further coupled to the collection section 27. In addition, the blower 262 is installed in the middle of the pipe 245. By operating the blower 262, a suction force can be generated in the suction section 153. Accordingly, the formation of the first web M5 is promoted on the mesh belt 151. Dust, dirt, or the like is removed from the first web M5. Further, the dust or dirt pass through the pipe 244 and reach the collection section 27 by the operation of the blower 262.

The housing section 142 is coupled to the humidification section 232. The humidification section 232 is configured as a vaporization type humidifier. As a result, humidified air is supplied into the housing section 142. The first sorted product M4-1 can be humidified by the humidified air, and thus adhesion of the first sorted product M4-1 to the inner wall of the housing section 142 due to the electrostatic force can be suppressed.

The humidification section 235 is disposed on the downstream of the sorting section 14. The humidification section 235 is configured as an ultrasonic humidifier that sprays water. As a result, moisture can be supplied to the first web M5, and thus the water content of the first web M5 is adjusted. By this adjustment, the adsorption of the first web M5 to the mesh belt 151 due to the electrostatic force can be suppressed. As a result, the first web M5 is easily peeled off from the mesh belt 151 at the position where the mesh belt 151 is folded back by the tension roller 152.

The subdivision section 16 is disposed on the downstream of the humidification section 235. The subdivision section 16 is a part that performs the division step of dividing the first web M5 peeled off from the mesh belt 151. The subdivision section 16 has a propeller 161 rotatably supported and a housing section 162 that stores the propeller 161. Then, the first web M5 can be divided by the rotating propeller 161. The divided first web M5 becomes a subdivided body M6. Further, the subdivided body M6 descends in the housing section 162.

The housing section 162 is coupled to the humidification section 233. The humidification section 233 is configured as a vaporization type humidifier. As a result, humidified air is supplied into the housing section 162. The humidified air can also suppress adhesion of the subdivided body M6 to the inner wall of the propeller 161 or the housing section 162 due to the electrostatic force.

The mixing section 17 is disposed on the downstream of the subdivision section 16. The mixing section 17 is a part that performs the mixing step of mixing the subdivided body M6 and an additive. The mixing section 17 includes an additive supply section 171, a pipe 172, and the blower 173.

The pipe 172 is a flow path which couples the housing section 162 of the subdivision section 16 and a housing 182 of the dispersion section 18, and through which the mixture M7 of the subdivided body M6 and the additive passes.

An additive supply section 171 is coupled to the middle of the pipe 172. The additive supply section 171 has a housing section 170 in which the additive is housed, and a screw feeder 174 provided in the housing section 170. By the rotation of the screw feeder 174, the additive in the housing section 170 is pushed out from the housing section 170 and supplied into the pipe 172. The additive supplied into the pipe 172 is mixed with the subdivided body M6 to form the mixture M7.

Herein, examples of the additive supplied from the additive supply section 171 include a binder for binding fibers to each other, a coloring agent for coloring fibers, an aggregation inhibitor for suppressing fiber aggregation, a flame retardant for making fibers and the like unlikely to burn, and a paper strength enhancing agent for enhancing a paper strength of the sheet S, and one type or a plurality of types of additives, among these, can be used in combination. Hereinafter, as an example, a case where the additive is a binder P1 will be described. The additive includes a binder that binds fibers to each other, and accordingly, the strength of the sheet S can be increased.

Examples of the binder P1 include: natural product-derived ingredients such as starch, dextrin, glycogen, amylose, hyaluronic acid, arrowroot, konjac, potato starch, etherified starch, esterified starch, natural gum glue, fiber-derived glue, seaweed, and animal protein; polyvinyl alcohol; polyacrylic acid; and polyacrylamide, and one or two or more selected from these can be used in combination. However, a natural product-derived ingredient is preferable, and starch is more preferable. Further, for example, thermoplastic resins such as various polyolefins, acrylic resins, polyvinyl chloride, polyester, and polyamide; and various thermoplastic elastomers can also be used.

Further, in the middle of the pipe 172, the blower 173 is installed on the downstream of the additive supply section 171. The action of the rotating section such as a blade of the blower 173 promotes mixing of the subdivided body M6 and the binder P1. In addition, the blower 173 can generate an airflow toward the dispersion section 18. The subdivided body M6 and the binder P1 can be stirred in the pipe 172 by this airflow. As a result, the mixture M7 is transported to the dispersion section 18 in a state where the subdivided body M6 and the binder P1 are uniformly dispersed. Further, the subdivided body M6 in the mixture M7 is loosened in the process of passing through the pipe 172 to become a finer fibrous form.

Although not illustrated, the blower 173 is electrically coupled to a control device 28, and the operation thereof is controlled. Further, by adjusting the air blowing volume of the blower 173, the amount of air sent into a drum 181 can be adjusted.

Although not illustrated, the end portion of the pipe 172 on the drum 181 side is branched into two, and the branched end portions are coupled to an introduction port (not illustrated) formed on the end surface of the drum 181, respectively.

The dispersion section 18 illustrated in FIG. 1 is a part that performs the loosening step of loosening and releasing fibers that are intertwined with each other in the mixture M7. The dispersion section 18 includes a drum 181 that introduces and releases the mixture M7 that is a defibrated product, and a housing 182 that stores the drum 181.

The drum 181 is formed of a cylindrical net body, and is a sieve that rotates around a central axis thereof. As the drum 181 rotates, fibers or the like smaller than the mesh opening of the net of the mixture M7 can pass through the drum 181. At that time, the mixture M7 is loosened and released together with the air. That is, the drum 181 functions as a release section that releases a material containing fibers.

The drum 181 is coupled to a driving source (not illustrated), and rotates by a rotational force output from the driving source. The driving source is electrically coupled to the control device 28, and the operation thereof is controlled.

Further, the housing 182 is coupled to the humidification section 234. The humidification section 234 is configured as a vaporization type humidifier. As a result, humidified air is supplied into the housing 182. The inside of the housing 182 can be humidified by the humidified air, and thus adhesion of the mixture M7 to the inner wall of the housing 182 due to the electrostatic force can be suppressed.

In addition, the mixture M7 released by the drum 181 falls when being dispersed in the air, and is oriented toward the second web forming section 19 positioned below the drum 181. The second web forming section 19 is a part that performs the second web forming step of accumulating the mixture M7 to form the second web M8 which is an accumulated product. The second web forming section 19 includes a mesh belt 191, a tension roller 192, and a suction section 193.

The mesh belt 191 is a mesh member, and in the illustrated configuration, the mesh belt 191 is configured as an endless belt. Further, the mixture M7 dispersed and released by the dispersion section 18 is accumulated on the mesh belt 191. The mesh belt 191 is hung around four tension rollers 192. Then, the mixture M7 on the mesh belt 191 is transported to the downstream by the rotational drive of the tension roller 192.

In the illustrated configuration, the mesh belt 191 is used as an example of the mesh member, but the present disclosure is not limited to this, and for example, a flat plate shape may be used.

In addition, most of the mixture M7 on the mesh belt 191 has a size equal to or larger than the mesh opening of the mesh belt 191. As a result, the passage of the mixture M7 through the mesh belt 191 is restricted, and accordingly, the mixture M7 can be accumulated on the mesh belt 191. In addition, since the mixture M7 is transported to the downstream along with the entire mesh belt 191 when being accumulated on the mesh belt 191, the mixture M7 is formed as a layered second web M8.

The suction section 193 is a suction mechanism that suctions air from below the mesh belt 191. Thereby, the mixture M7 can be suctioned onto the mesh belt 191, and thus the accumulation of the mixture M7 on the mesh belt 191 is promoted.

A pipe 246 is coupled to the suction section 193. In addition, the blower 263 is installed in the middle of the pipe 246. By operating the blower 263, a suction force can be generated in the suction section 193.

The humidification section 236 is disposed on the downstream of the dispersion section 18. The humidification section 236 is configured as an ultrasonic humidifier, which is the same as the humidification section 235. As a result, moisture can be supplied to the second web M8, and thus the water content of the second web M8 is adjusted. By this adjustment, the adsorption of the second web M8 to the mesh belt 191 due to the electrostatic force can be suppressed. As a result, the second web M8 is easily peeled off from the mesh belt 191 at the position where the mesh belt 191 is folded back by the tension roller 192.

The total water content added to the humidification section 231 to the humidification section 236 is preferably, for example, 0.5 parts by mass or more and 20 parts by mass or less with respect to 100 parts by mass of the material before humidification.

The molding section 20 is disposed on the downstream of the second web forming section 19. The molding section 20 is a part that performs the sheet forming step of forming the sheet S from the second web M8. The molding section 20 has a pressurization section 201 and a heating section 202.

The pressurization section 201 has a pair of calendar rollers 203, and can pressurize the second web M8 between the calendar rollers 203 without heating. Thereby, the density of the second web M8 is increased. The degree of heating in the case of heating is preferably a degree that the binder P1 is not melted, for example. Then, the second web M8 is transported toward the heating section 202. One of the pair of calendar rollers 203 is a main roller driven by the operation of a motor (not illustrated), and the other is a driven roller.

The heating section 202 has a pair of heating rollers 204, and can pressurize the second web M8 when heating the second web M8 between the heating rollers 204. By this heating and pressurization, the binder P1 is melted in the second web M8, and the fibers are bound to each other via the melted binder P1. Accordingly, the sheet S is formed. Then, the sheet S is transported toward the cutting section 21. One of the pair of heating rollers 204 is a main roller driven by the operation of a motor (not illustrated), and the other is a driven roller.

The cutting section 21 is disposed on the downstream of the molding section 20. The cutting section 21 is a part that performs the cutting step of cutting the sheet S. The cutting section 21 has a first cutter 211 and a second cutter 212.

The first cutter 211 cuts the sheet S in a direction intersecting the transport direction of the sheet S, particularly a direction orthogonal to the transport direction.

The second cutter 212 is located downstream of the first cutter 211 and cuts the sheet S in a direction parallel to the transport direction of the sheet S. This cutting is for removing unnecessary parts of both side end portions of the sheet S in a width direction to adjust the width of the sheet S.

Through such cutting with the first cutter 211 and the second cutter 212, the sheet S having a desired shape and a desired size is obtained. Then, the sheet S is transported further downstream and is accumulated in the stock section 22.

Each section of the sheet manufacturing apparatus 100 is electrically coupled to the control device 28. The operation of each of these sections is controlled by the control device 28.

As illustrated in FIG. 1, the control device 28 includes a control section 281, a storage section 282, and a communication section 283.

The control section 281 has at least one processor and executes various programs stored in the storage section 282. As the processor, for example, a central processing unit (CPU) can be used. In addition, the control section 281 has various functions such as a function of controlling the drive of each part of the apparatus related to sheet manufacturing, such as a function of controlling the drive of the blower 261, and a drive control of a motor M, which will be described later, in the sheet manufacturing apparatus 100.

By controlling the energization of the blower 261 and the motor M by the control section 281, the blower 261 and the motor M are driven and rotated at a predetermined timing and a predetermined rotation speed, respectively. It is preferable that the blower 261 and the motor M be driven to substantially overlap in time. As a result, smooth passage of the raw material in the refining device 13 and favorable refinement treatment are promoted.

For example, a program related to sheet manufacturing is stored in the storage section 282. Regarding the refining of the raw material by the refining device 13, a program related to the operation sequence including conditions such as the operation timing and the rotation speed of the blower 261 and the motor M is stored.

The communication section 283 is configured as, for example, an I/O interface and communicates with each section of the sheet manufacturing apparatus 100. Further, the communication section 283 has a function of communicating with a computer or a server (not illustrated) via a network, for example.

The control device 28 may be built in the sheet manufacturing apparatus 100 or may be provided in an external device such as an external computer. Further, for example, the control section 281 and the storage section 282 may be integrated into one unit or may be configured as one unit, the control section 281 may be built in the sheet manufacturing apparatus 100 and the storage section 282 may be provided in an external device such as an external computer, or the storage section 282 may be built in the sheet manufacturing apparatus 100 and the control section 281 may be provided in an external device such as an external computer.

Next, the configuration of the refining device 13 will be described.

As illustrated in FIGS. 2, 3, 4, 5, and 6, the refining device 13 is a device that refines the crushed piece M2 as a supplied raw material. In the refining device 13 installed in the sheet manufacturing apparatus 100, the second sorted product M4-2 is also mixed with the crushed piece M2 as a raw material to be introduced, but the amount of the second sorted product M4-2 in the raw material is smaller than that of the crushed piece M2, and thus, the raw material to be introduced will be described below as the crushed piece M2.

As illustrated in FIG. 2, the refining device 13 includes a casing 3, a filter member 4 installed inside the casing 3, the rotor 5 installed to be rotatable inside the casing 3, and the motor M that rotationally drives the rotor 5. The crushed piece M2 introduced into the casing 3 is defibrated when passing between the outer peripheral portion of the rotating rotor 5 and the filter member 4, and becomes the defibrated product M3.

The rotation direction of the rotor 5 may be either clockwise or counterclockwise, and the rotation direction may be switchable. In the present embodiment, the rotation direction of the rotor 5 is indicated by an arrow in FIG. 3.

The casing 3 has a supply port 311 to which the crushed piece M2 is supplied and a discharge port 321 for discharging the generated defibrated product M3 to the outside of the casing 3. The casing 3 is a box-shaped member having an internal space S0 for storing the filter member 4 and the rotor 5.

The casing 3 has a rectangular parallelepiped outer shape. As illustrated in FIGS. 2, 4, and 5, the casing 3 has a front side wall portion 31 positioned on the +X axis side, a back side wall portion 32 positioned on the −X axis side, an upper side wall portion 33 positioned on the +Z axis side, a lower side wall portion 34 positioned on the −Z axis side, a side wall portion 35 positioned on the +Y axis side, and a side wall portion 36 positioned on the −Y axis side.

The supply port 311 formed by a through-hole is provided in the front side wall portion 31. The supply port 311 is formed at a position eccentric to a shaft 50 described later. The downstream end portion of the pipe body 6 is coupled to the supply port 311. As a result, the crushed piece M2 flowing down the pipe body 6 is supplied into the casing 3.

The lower side wall portion 34 is provided with the discharge port 321 configured by a through-hole. The upstream end portion of the pipe 242 is inserted into and coupled to the discharge port 321. As a result, the defibrated product M3 generated by the refining device 13 is transported to the downstream, that is, the sorting section 14 via the pipe 242.

As illustrated in FIG. 4, the front side wall portion 31 and the back side wall portion 32 rotatably support the shaft 50 of the rotor 5 via a shaft bearing 71 and a shaft bearing 72. Each of the front side wall portion 31 and the back side wall portion 32 is provided with a through-hole, and the shaft 50 of the rotor 5 is inserted through each through-hole. A rotation axis O of the shaft 50 is disposed in a direction parallel to the X axis.

The end portion of the shaft 50 on the back side wall portion 32 side protrudes from the back side wall portion 32 toward the −X axis side, and the motor M is coupled to the protruding part. The shaft 50 can rotate by the rotational force output by the motor M, and the rotor 5 can rotate.

As illustrated in FIG. 3, the rotor 5 includes the shaft 50, a plurality of plate-shaped tooth-forming members 52 fixed to the outer periphery of the shaft 50 and arranged along the X axis direction, and a fixing plate 53. When the rotor 5 rotates in the internal space S0, an airflow is formed toward the supply port 311, the outer peripheral side of each of the tooth-forming members 52, and the discharge port 321, and accordingly, the crushed pieces M2 and the defibrated product M3 are transferred from the upstream to the downstream in the refining device 13.

The tooth-forming member 52 is a plate material provided with a projection 520 that forms a blade 521 in the outer peripheral portion. Each tooth-forming member 52 arranged along the X axis direction is inserted through the shaft 50 in a state where the main surfaces thereof are joined to each other. The projections 520 are provided at equal intervals radially, that is, along the peripheral direction of the shaft 50. 13 projections 520 are provided in one tooth-forming member 52. However, the present disclosure is not limited to this configuration. The number of projections 520 may be 1 to 12 or 14 or more.

Each tooth-forming member 52 is disposed such that each projection 520 overlaps each other in the rotation axis O direction. The blade 521 is formed by the overlapping projections 520. The blade 521 is positioned at the outer peripheral portion when viewed as the entire rotor 51. In other words, the plurality of blades 521 are provided at predetermined intervals along the outer peripheral portion of the rotor 5. The blade 521 is separated from the filter member 4, which is provided on the outer periphery thereof, by a predetermined distance and is configured to rotate in a non-contact manner with the filter member 4.

The fixing plate 53 is disposed concentrically with each tooth-forming member 52 on the +X axis side of each tooth-forming member 52. Each tooth-forming member 52 is fixed to the fixing plate 53 via a fixing member such as a bolt or a screw (not illustrated).

According to such a configuration, the supplied crushed piece M2 enters the gap between each tooth-forming member 52 and the filter member 4, and is defibrated by the rotational force of each blade 521. In addition, the rotation of the rotor 5 and the operation of the blower 261 are combined to form an airflow that sequentially passes through the supply port 311, the space inside the filter member 4 in the internal space S0, an annular space S1, and the discharge port 321.

The rotation speed of the rotor 5 at the time of defibration is not particularly limited, but is preferably 1, 000 rpm or more and 300, 000 rpm or less, and more preferably 3,000 rpm or more and 15, 000 rpm or less. As a result, the crushing of the crushed piece M2 can be performed more satisfactorily.

As illustrated in FIG. 5, the filter member 4 is formed of a cylindrical member, and has a curved plate-shaped rigid body part 40 on the −Z axis side. The rigid body part 40 is provided with the flow rectifying member 8, which will be described later, and the part of the filter member 4 other than the rigid body part 40 is composed of a net-like portion, that is, a mesh 41. In the filter member 4, an edge portion on the −X axis side is fixed to the inner surface of the casing 3, that is, the inner surface of the back side wall portion 32. In addition, the outer peripheral portion of the filter member 4 is fixed to the inner surface of the casing 3 in a state of being separated by a predetermined distance. As a result, an annular space through which the fibers that passed through the mesh 41 flow toward the discharge port 321, that is, the annular space S1, is formed between the filter member 4 and the inner peripheral surface of the casing 3.

The mesh opening of the mesh 41 is such that only sufficiently defibrated fibers can pass therethrough. When the defibration is insufficient, the crushed piece M2 is positioned inside the filter member 4 of the internal space S0, that is, on the blade 521 side without passing through the mesh 41, and until the defibration is sufficiently performed, the defibration is performed between the rotating blade 521 and the filter member 4.

As illustrated in FIGS. 4 and 5, the fibers that are sufficiently defibrated and disentangled one by one, that is, the defibrated product M3 passes through the mesh 41 of the filter member 4 together with the air, and moves to the annular space S1, which is a space between the filter member 4 and the inner peripheral surface of the casing 3.

The annular space S1 has an annular shape, particularly a circular shape when viewed in the X axis direction. The annular space S1 communicates with the discharge port 321 in the lower side part. The annular space S1 is a space that is coupled over the entire periphery of the outer periphery of the filter member 4. However, the present disclosure is not limited to this configuration, and a part of the annular space S1 in the peripheral direction, for example, an upper side part may be interrupted.

As illustrated in FIG. 5, during the defibration of the crushed piece M2, in the annular space S1, when viewed in the axial direction of the rotation axis O of the rotor 5, a first airflow A1 flowing clockwise through the annular space S1 and a second airflow A2 flowing counterclockwise through the annular space S1 are generated. The first airflow A1 and the second airflow A2 join in the vicinity of the discharge port 321, and are discharged from the discharge port 321 after joining. The defibrated products M3 that passed through each section of the mesh 41 join each other in the vicinity of the discharge port 321 along the flow of the first airflow A1 or the second airflow A2, is discharged from the discharge port 321 after joining, and is transferred downstream in the pipe 242.

As described above, the refining device 13 includes a first airflow A1 and a second airflow A2 flowing in mutually opposite directions within the annular space S1, and a joining section 200 at which the first airflow A1 and the second airflow A2 join, and the defibrated products M3 included in the airflows joined at the joining section 200 is discharged from the discharge port 321 (refer to FIG. 6).

As illustrated in FIGS. 5 and 6, the refining device 13 includes the flow rectifying member 8 provided in the annular space S1 and protruding toward the discharge port 321. That is, the flow rectifying member 8 is provided on the outer peripheral surface of the rigid body part 40 of the filter member 4 to protrude toward the discharge port 321. The rigid body part 40 functions as a support section of the flow rectifying member 8.

The flow rectifying member 8 has a function of rectifying the airflow in the vicinity of the discharge port 321 of the annular space S1 and forming a good airflow toward the discharge port 321. More specifically, in the lower part of the annular space S1, the first airflow A1 and the second airflow A2 join at the joining section 200 and are oriented toward the discharge port 321, but by installing the flow rectifying member 8, the first airflow A1 and the second airflow A2 each change the direction to be oriented downward immediately before the joining section 200, and the resistance and loss due to the joining are reduced to smoothly join, and the joined airflow can be oriented toward the discharge port 321 without reducing the flow velocity as much as possible. As a result, the defibrated product M3 can be prevented from staying in the vicinity of the discharge port 321 and to smoothly discharge the defibrated product M3 from the discharge port 321. Therefore, the amount of the defibrated product M3 discharged from the refining device 13 per unit time can be stabilized. As a result, in the sheet manufacturing apparatus 100 including the refining device 13, the quality of the sheet S can be improved. In addition, since the frequency of stopping the refining device 13 to perform maintenance is also reduced due to the stay and clogging of the defibrated product M3, the decrease in the production efficiency of the defibrated product M3 (refined product), particularly the decrease in the production efficiency of the sheet S can be prevented.

In the present embodiment, since the flow rectifying member 8 is provided in the joining section 200, the joining of the first airflow A1 and the second airflow A2 can be smoothly and appropriately performed, and the direction of the airflow after the joining can be optimized and the flow velocity can be secured. That is, in the joining section 200 at which the defibrated product M3 is relatively likely to stay, the stay of the defibrated product M3 can be prevented in advance, and the discharge from the discharge port 321 can be smoothly performed.

As illustrated in FIG. 6, the flow rectifying member 8 is a block-shaped member having a triangular cross-sectional shape cut along a plane having the rotation axis O as a normal line. The flow rectifying member 8 has a first flow rectifying surface 81, a second flow rectifying surface 82, and a top portion 83. The inside of the flow rectifying member 8 may be hollow.

The first flow rectifying surface 81 is positioned on the downstream of the first airflow A1, that is, on the +Y axis side, and rectifies the first airflow A1. The first flow rectifying surface 81 is configured on a plane inclined with respect to the Y axis and the Z axis. The first airflow A1 has a route (flow direction) changed to the discharge port 321 side by the first flow rectifying surface 81, and smoothly flows toward the discharge port 321.

The second flow rectifying surface 82 is positioned on the downstream of the second airflow A2, that is, on the −Y axis side, and rectifies the second airflow A2. The second flow rectifying surface 82 is inclined with respect to the Y axis and the Z axis, and is configured as a planar surface having a shape symmetrical to the first flow rectifying surface 81 with respect to the XZ plane passing through the top portion 83. The second airflow A2 has a route changed to the discharge port 321 side by the second flow rectifying surface 82 and smoothly flows toward the discharge port 321.

However, the present disclosure is not limited to this configuration, and at least one of the first flow rectifying surface 81 and the second flow rectifying surface 82 may be formed of a curved surface (curved convex surface or curved concave surface).

The top portion 83 is positioned at the boundary between the first flow rectifying surface 81 and the second flow rectifying surface 82, and is configured to be a pointed part (edge portion) protruding downward. A pointed part of the top portion 83 extends along the X axis and forms an edge. The top portion 83 may be inclined in any direction with respect to the X axis. In addition, the top portion 83 may not be pointed. That is, the top portion 83 may be rounded or may be formed in a flat surface.

The top portion 83 overlaps the discharge port 321 when viewed in the Z axis direction. In other words, the position of the top portion 83 in the peripheral direction of the annular space S1 coincides with the discharge port 321. As a result, the first airflow A1 and the second airflow A2, the route of which is changed by the flow rectifying member 8, can be more reliably directed toward the discharge port 321. Therefore, the defibrated product M3 can be more smoothly discharged from the discharge port 321.

As described above, the position of the top portion 83 in the peripheral direction of the annular space S1 coincides with the discharge port 321. As a result, the defibrated product M3 can be more smoothly discharged from the discharge port 321.

The position of the top portion 83 in the peripheral direction of the annular space S1 may be shifted from the discharge port 321. That is, the top portion 83 may not overlap the discharge port 321 when viewed in the Z axis direction.

In addition, the top portion 83 overlaps a central axis O1 of the discharge port 321 when viewed in the Z axis direction. In other words, the position of the top portion 83 in the peripheral direction of the annular space S1 coincides with the central axis O1 of the discharge port 321. As a result, the defibrated product M3 can be more smoothly discharged from the discharge port 321.

Note that the position of the top portion 83 in the peripheral direction of the annular space S1 may be shifted from the central axis O1 of the discharge port 321. That is, the top portion 83 may not overlap the central axis O1 of the discharge port 321 when viewed in the Z axis direction.

In addition, although not illustrated, the length of the flow rectifying member 8 in the X axis direction is the same as the length of the filter member 4 in the X axis direction. That is, the first flow rectifying surface 81 and the second flow rectifying surface 82 are formed over the entire region of the filter member 4 in the X axis direction. As a result, the first airflow A1 and the second airflow A2 can be more effectively rectified.

The length of the flow rectifying member 8 in the X axis direction is preferably 50% or more, more preferably 70% or more, and still more preferably 90% or more of the length of the filter member 4 in the X axis direction. As a result, the first airflow A1 and the second airflow A2 can be effectively rectified.

The first flow rectifying surface 81 and the second flow rectifying surface 82 respectively have a rectangular shape in plan view, and have the same size. That is, the first flow rectifying surface 81 and the second flow rectifying surface 82 respectively have the same length in the X axis direction at any position in the Z axis direction. As a result, the effect of the flow rectifying can be stably exhibited.

The first flow rectifying surface 81 and the second flow rectifying surface 82 may have parts having different lengths in the X axis direction. For example, the first flow rectifying surface 81 and the second flow rectifying surface 82 may have a shape that includes a part in which the length in the X axis direction decreases as going to the −Z axis side.

As illustrated in FIG. 6, an inclination angle O1 of the first flow rectifying surface 81 with respect to the Y axis is not particularly limited, and is, for example, preferably 10° or more and 80° or less, and more preferably 20° or more and 70° or less. As a result, the rectifying of the first airflow A1 can be performed more effectively.

When the first flow rectifying surface 81 is a curved surface, the intermediate value between the maximum value and the minimum value of the inclination angle is set as the inclination angle θ1.

An inclination angle θ2 of the second flow rectifying surface 82 with respect to the Y axis is not particularly limited, and is, for example, preferably 10° or more and 80° or less, and more preferably 20° or more and 70° or less. As a result, the rectifying of the second airflow A2 can be performed more effectively.

When the second flow rectifying surface 82 is a curved surface, the intermediate value between the maximum value and the minimum value of the inclination angle is set as the inclination angle θ2.

In the flow rectifying member 8, the inclination angle θ1 and the inclination angle θ2 are the same. As a result, the rectifying of the first airflow A1 and the second airflow A2 can be equally and well balanced. However, the present disclosure is not limited to this configuration, and the inclination angle θ1 and the inclination angle θ2 may be different. In this case, it is preferable to appropriately set the inclination angle θ1 and the inclination angle θ2 in consideration of the balance of the flow rates of the first airflow A1 and the second airflow A2, the shape of the annular space S1, and the like.

When the protrusion height of the top portion 83 from the filter member 4 is defined as L1 and the average length of the annular space S1 in the radial direction of the rotor 5 is defined as L2, L1/L2 is not particularly limited, but is preferably 0.4 or more and less than 1.0, and more preferably 0.5 or more and 0.8 or less. As a result, the first airflow A1 and the second airflow A2 can be rectified more appropriately and more effectively.

As described above, when the protrusion height of the top portion 83 from the filter member 4 is defined as L1 and the average length of the annular space S1 in the radial direction of the rotor 5 is defined as L2, L1/L2 is preferably 0.4 or more and less than 1.0. As a result, the first airflow A1 and the second airflow A2 can be rectified more appropriately and more effectively.

As described above, the refining device 13 includes the casing 3 that has the supply port 311 to which the crushed piece M2 is supplied, which is an example of the raw material including a fiber, and the discharge port 321 for discharging the defibrated product M3, which is an example of the refined product obtained by refining the crushed piece M2; the rotor 5 that is rotatably installed in the casing 3 and has the plurality of blades 521 disposed radially from the rotation axis O; the filter member 4 that is installed in the casing 3 to cover an outer periphery of the rotor 5 and is composed at least partially of the mesh 41; and the flow rectifying member 8 that is positioned in the annular space S1 between the filter member 4 and an inner peripheral surface of the casing 3 and protrudes toward the discharge port 321. As a result, the defibrated product M3 can be prevented from staying in the vicinity of the discharge port 321 and to smoothly discharge the defibrated product M3 from the discharge port 321. As a result, the refinement treatment can be smoothly and stably continued. In addition, when the sheet manufacturing apparatus 100 includes the refining device 13, the high-quality sheet S can be stably and efficiently manufactured.

Although the configuration in which the annular space S1 communicates with the entire periphery was described, the present disclosure is not limited thereto, and a part of the annular space S1 may be blocked. That is, a C-shaped space or the like in which a part is interrupted is also included in the annular space. For example, the upper part of the annular space S1 in FIG. 5 can be a part that is blocked.

In addition, the annular space S1 may not have a circular shape, may have an elliptical annular shape, or may have a partially angular portion.

The refining device 13 includes the joining section 200 at which the first airflow A1 flowing clockwise through the annular space S1 and the second airflow A2 flowing counterclockwise through the annular space S1 join, when viewed in an axial direction of the rotation axis O of the rotor 5, and the flow rectifying member 8 is provided at the joining section 200. Accordingly, in the joining section 200 at which the defibrated product M3 is relatively likely to stay, the stay of the defibrated product M3 can be prevented in advance. As a result, the defibrated product M3 can be smoothly discharged from the discharge port 321.

In the annular space S1, the flow velocity and the flow rate of the first airflow A1 and the second airflow A2 may not be uniform, and the first airflow A1 and the second airflow A2 may flow in only one direction.

The flow rectifying member 8 has the first flow rectifying surface 81 that rectifies the first airflow A1, the second flow rectifying surface 82 that rectifies the second airflow A2, and the top portion 83 provided between the first flow rectifying surface 81 and the second flow rectifying surface 82. As a result, the first airflow A1 and the second airflow A2 can be rectified well, respectively. As a result, the first airflow A1 and the second airflow A2 are appropriately and satisfactorily joined, and the defibrated product M3 can be smoothly discharged from the discharge port 321.

In the present embodiment, the configuration in which the flow rectifying member 8 has two flow rectifying surfaces, that is, the first flow rectifying surface 81 and the second flow rectifying surface 82 were described, but the present disclosure is not limited thereto, and the number of flow rectifying surfaces may be one or three or more.

In addition, as described above, the filter member 4 has a cylindrical shape, and the part other than the rigid body part 40, which is a part provided with the flow rectifying member 8, is configured with the mesh 41. As a result, the passage of the defibrated product M3 can be sufficiently secured and the flow rectifying member 8 can be stably installed, and the rectifying of the airflow can be performed by the flow rectifying member 8 in a good and stable manner.

The entire region of the filter member 4 may be formed of the mesh 41. In addition, the filter member 4 may be configured of a frame member or a porous portion member having the same function as the mesh 41 in whole or in part.

### Second Embodiment

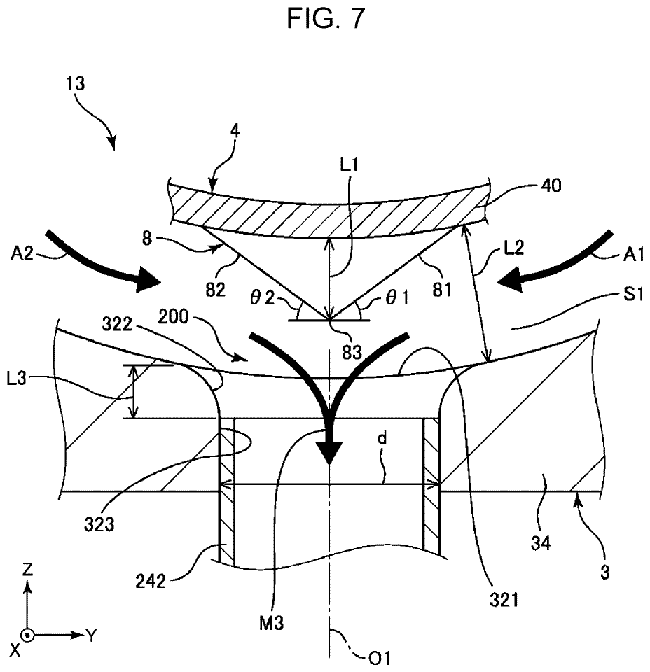

FIG. 7 is an enlarged cross-sectional view in the vicinity of a discharge port provided in the refining device according to a second embodiment of the present disclosure.

Hereinafter, the second embodiment of the refining device of the disclosure will be described with reference to FIG. 7, but differences from the first embodiment will be mainly described below, and the description of common points will be omitted.

As illustrated in FIG. 7, in the refining device 13 of the present embodiment, the upper edge portion of the discharge port 321 is chamfered or is provided with an R rounding over the entire periphery. That is, the discharge port 321 has, at the upper end thereof, a gradually increasing section 322 in which the inner diameter gradually increases as going to the +Z axis side, and an inner diameter constant section 323 which is positioned on the −Z axis side of the gradually increasing section 322 and has a constant inner diameter.

The inner diameter gradual increase rate of the gradually increasing section 322 increases as it goes to the +Z axis side, and the inner surface of the gradually increasing section 322 is a curved surface. However, the present disclosure is not limited to this configuration, and the inner diameter gradual increase rate of the gradually increasing section 322 may be constant, or may be reduced as going to the +Z axis side.

By providing the gradually increasing section 322, the presence of the flow rectifying member 8 can prevent or alleviate the narrowing of the annular space S1 at a part in the vicinity of the discharge port 321, and the first airflow A1 and the second airflow A2 rectified by the flow rectifying member 8 can be smoothly joined together without reducing the flow velocity. Further, since the gradually increasing section 322 is provided, the first airflow A1 and the second airflow A2 rectified by the flow rectifying member 8 can be guided along the inner peripheral portion of the gradually increasing section 322 and flow into the discharge port 321. Due to the synergistic effect of such actions, the stay of the defibrated product M3 in the vicinity of the discharge port 321 can be more effectively prevented, and the defibrated product M3 can be more smoothly discharged from the discharge port 321.

In addition, when the inner diameter of the inner diameter constant section 323 is defined as d and the length of the gradually increasing section 322 in the Z axis direction is defined as L3, L3/d is preferably 0.01 or more and 1.5 or less, and more preferably 0.1 or more and 0.9 or less. As a result, the formation region of the gradually increasing section 322 can be secured to be necessary and sufficient, and the above effect can be more reliably exhibited.

As described above, the edge portion of the discharge port 321 is chamfered or is provided with an R rounding. As a result, the stay of the defibrated product M3 in the vicinity of the discharge port 321 can be more effectively prevented, and the defibrated product M3 can be more smoothly discharged from the discharge port 321. As a result, the refinement treatment can be more smoothly and stably continued. In addition, when the sheet manufacturing apparatus 100 includes the refining device 13, the high-quality sheet S can be stably and efficiently manufactured.

### Third Embodiment

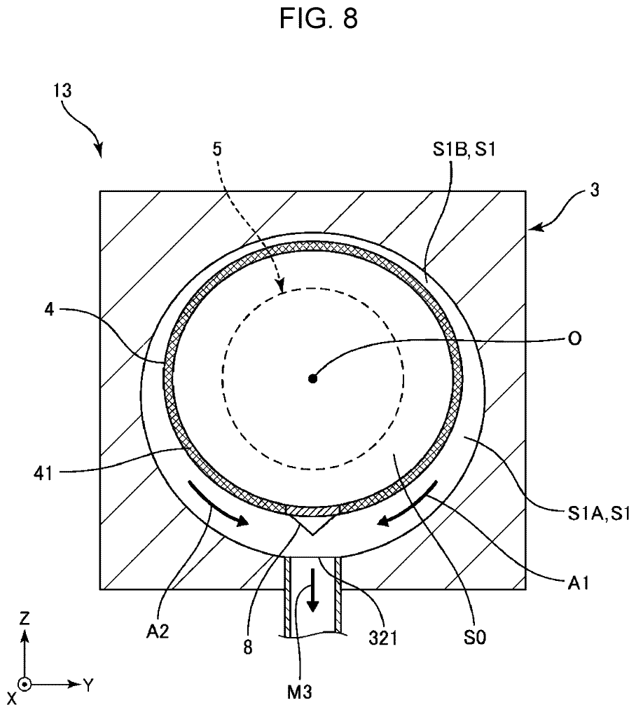

FIG. 8 is an enlarged cross-sectional view in the vicinity of a discharge port provided in the refining device according to a third embodiment of the present disclosure.

Hereinafter, the third embodiment of the refining device of the disclosure will be described with reference to FIG. 8, but differences from the first embodiment will be mainly described below, and the description of common points will be omitted.

As illustrated in FIG. 8, in the refining device 13 of the present embodiment, the length of the annular space S1 becomes longer in the radial direction of the rotor 5 as going to the −Z axis side. That is, the length of the rotor 5 in the radial direction of the annular space S1 is longer on the discharge port 321 side than on the side opposite to the discharge port 321 via the rotation axis O. Hereinafter, a specific description will be given.

The annular space S1 is divided into upper and lower parts at the position where a rotation axis O exists in the Z axis direction, that is, at the dotted line in FIG. 8, a space on the discharge port 321 side is an annular space SIA, and a space on the side opposite to the discharge port via the rotation axis O is an annular space S1B.

The maximum value of the length of the rotor 5 in the radial direction in the annular space SA is longer than the maximum value of the length of the rotor 5 in the radial direction in the annular space S1B.

In addition, the average value of the length of the rotor 5 in the radial direction in the annular space S1A is longer than the average value of the length of the rotor 5 in the radial direction in the annular space S1B.

In the present embodiment, the filter member 4 and the rotor 5 are installed in a state of being unevenly disposed on the upper side of the internal space S0 of the casing 3, thereby forming the above-described configuration in which the annular space SIA and the annular space S1B having different lengths in the radial direction of the rotor 5 are provided.

According to such a configuration, since the annular space SIA in the vicinity of the discharge port 321 is large, even when lumps (small lumps in which the fibers are intertwined with each other) are generated in the defibrated product M3 that passed through the filter member 4, the lumps can be discharged from the discharge port 321. Therefore, the stay of the defibrated product M3 in the vicinity of the discharge port 321 can be more effectively prevented, and the defibrated product M3 can be more smoothly discharged from the discharge port 321.

As described above, the length of the rotor 5 in the radial direction of the annular space S1 (in the present embodiment, both the maximum value and the average value) is longer on the discharge port 321 side than on the side opposite to the discharge port 321 via the rotation axis O. As a result, the stay of the defibrated product M3 in the vicinity of the discharge port 321 can be more effectively prevented, and the defibrated product M3 can be more smoothly discharged from the discharge port 321. As a result, the refinement treatment can be further smoothly and stably continued. In addition, when the sheet manufacturing apparatus 100 includes the refining device 13, the high-quality sheet S can be manufactured more stably and efficiently.

Although the refining device of the present disclosure was described above with respect to each of the illustrated embodiments, the present disclosure is not limited thereto, and any section constituting the refining device can be replaced with any one having a configuration that can exhibit the same function. In addition, any component may be added to the refining device.

Further, in the sheet manufacturing apparatus, the raw material supply section 11 and the crushing section 12 may be omitted. In this case, the sheet manufacturing apparatus includes a crushed piece supply section that supplies the crushed piece, instead of the raw material supply section 11 and the crushing section 12.

What is claimed is:

1. A refining device comprising:
a casing that has a supply port to which a raw material containing a fiber is supplied and a discharge port for discharging a refined product obtained by refining the raw material;
a rotor that is rotatably installed in the casing and has a plurality of blades disposed radially from a rotation axis;
a filter member that is installed in the casing to cover an outer periphery of the rotor and is composed at least partially of a mesh; and
a flow rectifying member that is positioned in an annular space between the filter member and an inner peripheral surface of the casing and protrudes toward the discharge port.

2. The refining device according to claim 1, further comprising:
a joining section at which a first airflow flowing clockwise through the annular space and a second airflow flowing counterclockwise through the annular space join, when viewed in an axial direction of the rotation axis of the rotor, wherein
the flow rectifying member is provided at the joining section.

3. The refining device according to claim 2, wherein
the flow rectifying member includes a first flow rectifying surface that rectifies the first airflow, a second flow rectifying surface that rectifies the second airflow, and a top portion provided between the first flow rectifying surface and the second flow rectifying surface.

4. The refining device according to claim 3, wherein
a position of the top portion in a peripheral direction of the annular space coincides with the discharge port.

5. The refining device according to claim 4, wherein
when a protrusion height of the top portion from the filter member is defined as L1 and an average length of the annular space in a radial direction of the rotor is defined as L2, L1/L2 is 0.4 or more and less than 1.0.

6. The refining device according to claim 1, wherein
the filter member has a cylindrical shape, and is composed of the mesh except for a part where the flow rectifying member is provided.

7. The refining device according to claim 1, wherein
an edge portion of the discharge port is chamfered or is provided with an R rounding.

8. The refining device according to claim 1, wherein
a length of the annular space in a radial direction of the rotor is longer on a discharge port side than on a side opposite to the discharge port with respect to the rotation axis.
